(19) United States
(12) Patent Application Publication
(10) Pub. No.: US 2003/0018095 A1
(43) Pub. Date: Jan. 23, 2003

(54) Thermosettable compositions useful for producing structural adhesive foams

(76) Inventor: Rajat K. Agarwal, Rochester Hills, MI (US)

Correspondence Address: Henkel Corporation, Law Department, Suite 200, 2500 Renaissance Blvd., Gulph Mills, PA, 19406, US

(21) Appl. No.: 09/844,200

(22) Filed: Apr. 27, 2001

(51) Int. Cl. C08J 9/00

(52) U.S. Cl. 521/59

(57) ABSTRACT

The use of an adduct of an isocyanate resin and an isocyanate-reactive liquid or semi-solid epoxy resin in an expandable thermosettable composition helps to reduce the tackiness of the composition and also increases its dimensional stability, as compared to compositions in which only non-adducted liquid or semi-solid epoxy resins are present

### FIELD OF THE INVENTION

The invention relates to thermosettable and expandable compositions which have reduced surface tack and/or improved dimensional stability in their uncured state. Such compositions are useful for producing foams which are capable of bonding substrates to one another to enhance the strength and stiffness of such substrates with minimal increase in weight.

### DISCUSSION OF THE RELATED ART

It is known that a number of industries, e.g., the automobile industry, require parts that are both strong and lightweight. One attempt to achieve this balance between strength and minimal weight utilizes hollow parts constructed of relatively thin sheet metal. However, hollow metal parts are easily distorted. Accordingly, it is also known that the presence of structural foam in the cavities of the hollow parts can improve the strength and stiffness of such parts.

Generally, such foams are prepared from formulations comprising a thermosettable resin such as epoxy resins, curatives, blowing agents and fillers and reinforcing agents such as hollow glass microspheres. Preferably, these foams have a density of about 20-40 lb/ft³ (about 0.30-0.65 g/cc) and are able to withstand heat in excess of 175° C., most preferably in excess of 200° C.

Such formulations commonly employ liquid and/or semi-solid epoxy resins as a major or predominant component of the thermosettable composition. Such epoxy resins are relatively inexpensive and have the additional advantage of being readily mixed or blended with the other components of the thermosettable composition. Unfortunately, the resulting thermosettable compositions tend to be tacky and soft and to be dimensionally unstable. That is, although such thermosettable compositions may be easily molded or formed into a desired shape, they generally do not retain such shape when subjected to additional handling or processing at ambient temperatures. These characteristics make it difficult to use the thermosettable compositions in combination with other components to form an assembly. For example, it may be desirable to produce a drop-in insert for reinforcing a hollow cavity of a vehicle where the insert is comprised of a carrier and a block or sheet of the thermosettable composition affixed to the carrier. When the thermosettable composition is tacky and/or incapable of retaining the desired shape, the assembly and subsequent handling of the insert can be messy and tedious.

It would therefore be highly desirable to develop an expandable thermosettable composition useful as a precursor for making a structural adhesive foam wherein the thermosettable composition has reduced surface tack and is dimensionally stable.

### SUMMARY OF THE INVENTION

The invention provides a reduced tack expandable thermosettable composition of improved dimensional stability which is useful for producing a structural adhesive foam. Such composition is comprised of at least one adduct obtained by reacting an isocyanate resin with a liquid or semi-solid epoxy resin bearing at least one isocyanate-reactive functional group, at least one blowing agent and at least one epoxy curative.

### DETAILED DESCRIPTION OF THE INVENTION

The thermosettable compositions of the invention utilize one or more adducts obtainable by reacting an isocyanate resin with a liquid or semi-solid epoxy resin containing at least one isocyanate-reactive functional group such as a hydroxyl group or primary or secondary amino group or other functional group containing at least one active hydrogen. Without wishing to be bound by theory, it is believed that the isocyanate resin in effect acts as a chain extender or crosslinker to join together individual molecules of the epoxy resin. The epoxy resin can therefore, in effect, be “B” staged upon the addition of the isocyanate resin. The molecular weight of the adduct thereby is increased relative to the molecular weight of the starting epoxy resin, which reduces the tack and improves the dimensional stability of the thermosettable composition. However, this reaction is controlled by adjusting parameters such as the isocyanate resin:epoxy resin ratio in order to avoid excessive cross-linking and to enable the thermosettable composition to still be molded, shaped or formed into the desired configuration. The reaction of the isocyanate resin and epoxy resin is preferably carried out under conditions such that the epoxy functional groups in both the adduct and any unadducted epoxy resin which may be present remain substantially (preferably, entirely) unreacted.

Although the presence of the adduct serves to reduce the surface tack and improve dimensional stability, the other properties of the expandable thermosettable composition such as % expansion, lap shear, and compressive modulus are not adversely affected.

The isocyanate resin may be any organic compound containing at least two isocyanate groups per molecule (more preferably, at least three isocyanate groups per molecule). Preferably, free isocyanate groups are present, but it is also possible to use compounds containing blocked or masked isocyanate groups provided such blocked or masked isocyanate groups are capable of reacting with the isocyanate-reactive groups under conditions where reaction of the epoxy groups is substantially avoided (i.e., the blocked or masked isocyanate groups react at a temperature substantially lower than the temperature which is required to initiate curing of the epoxy groups).

The isocyanate resin may be aliphatic or aromatic in character. Illustrative isocyanate resins suitable for use in the present invention include, without limitation, TDI, MDI, PMDI, HDI, PPDI, NDI, TODI, XDI, TMXDI, TMDI, CHDI, BDI, H₆XDI, IPDI, H₁₂MDI and the like. Trifunctional isocyanate resins such as, for example, trimers (isocyanurates) of the aforementioned diisocyanates (e.g., HDI trimer) and triphenylmethane 4,4′,4″-triisocyanate, are especially preferred for use. Mixtures of two or more different isocyanate resins may be employed.

Any of the thermosettable resins having an average of more than one (preferably about two or more) epoxy groups per molecule and an average of at least one (preferably about two or more) isocyanate-reactive groups per molecule known or referred to in the art may be utilized as the epoxy resin component of the present invention. Preferred isocyanate-reactive groups are moieties containing at least one active hydrogen atom such as hydroxyl (—OH) and primary or secondary amino (e.g., —NH₂) groups.

Such epoxy resins are described, for example, in the chapter entitled “Epoxy Resins” in the Second Edition of the Encyclopedia of Polymer Science and Engineering, Volume 6, pp. 322-382 (1986). Exemplary epoxy resins include polyglycidyl ethers obtained by reacting polyhydric phenols such as bisphenol A, bisphenol F, bisphenol AD, catechol, resorcinol, or polyhydric alcohols such as glycerin and polyethylene glycol with haloepoxides such as epichlorohydrin; glycidylether esters obtained by reacting hydroxycarboxylic acids such as p-hydroxybenzoic acid or beta-hydroxy naphthoic acid with epichlorohydrin or the like; polyglycidyl esters obtained by reacting polycarboxylic acids such as phthalic acid; tetrahydrophthalic acid or terephthalic acid with epichlorohydrin or the like; epoxidated phenolic-novolac compounds; and glycidated aminoalcohol compounds and aminophenol compounds. Mixtures of different resins may be used if so desired; for example, mixtures of liquid (at room temperature), semi-solid, and/or solid epoxy resins can be employed, provided at least a portion of the epoxy resin component is comprised of liquid and/or semi-solid epoxy resin. The thermosettable composition may be comprised not only of the isocyanate resin/epoxy resin adduct but also unreacted (non-adducted) epoxy resin. Epoxy resins which are not reactive towards isocyanate groups may be used in combination with isocyanate-reactive epoxy resins. Any of the epoxy resins available from commercial sources are suitable for use in the present invention. Preferably, the epoxy resin has an epoxide equivalent molecular weight of from about 180 to about 300. The use of epoxy resins based on glycidyl ethers of bisphenol A is especially advantageous. The epoxy resin preferably contains 2 epoxy groups per molecule and should be selected so as to provide the desired combination of properties in both the thermosettable composition and the final cured thermoset and composite prepared therefrom.

The weight ratio of epoxy resin: isocyanate resin and the molar ratio of isocyanate-reactive groups (e.g., —OH): isocyanate groups are not believed to be particularly critical and may be selected and adjusted as needed depending upon the chemical identity and properties of the epoxy resin and isocyanate resin components and the desired characteristics of the expandable thermosettable composition. In general, sufficient isocyanate resin is utilized to effect an increase in the needle penetration value of the composition as compared to an analogous composition which does not contain any isocyanate resin. If a relatively large proportion of a liquid (low melting) relatively low molecular weight diglycidyl ether bisphenol A epoxy resin is employed, for example, a greater quantity of isocyanate may be needed to achieve a desired needle penetration value than would be the case if a semi-solid (higher melting) higher molecular weight diglycidyl ether bisphenol A is used.

Similarly, the precise conditions under which the epoxy resin and the isocyanate resin are reacted to form the adduct may be readily controlled and determined as appropriate depending upon the chemical structures and relative reactivities of the components. For instance, the use of an epoxy resin containing primary, sterically unhindered hydroxyl groups will generally permit adduct formation to be accomplished at a lower temperature and/or in a shorter period of time than would be the case using an epoxy resin containing secondary or sterically hindered hydroxyl groups. If the adduct is to be formed in situ in the expandable thermosettable composition, the reaction temperature is preferably maintained below the temperature at which curing of the epoxy groups of the epoxy resin or activation of the blowing agent begins to occur at a significant rate. If necessary, the desired reaction between the epoxy resin and the isocyanate resin may be accelerated through the addition of one or more of the catalysts known in the art to be capable of increasing the rate of urethane formation. Such catalysts are well-known in the polyurethane art and include, for example, bismuth compounds (e.g., bismuth carboxylates), tin compounds, and the like. The urethane catalyst selected should not be a material which appreciably affects the rate of epoxy crosslinking or blowing agent activation at the temperature used for adduct preparation.

The hardening of the thermosettable composition may be accomplished by the addition of any of the chemical materials known in the art for curing epoxy resins. Such materials are referred to herein as “epoxy curatives”, but also include the substances known to workers in the field as curing agents, hardeners, activators, catalysts or accelerators. While certain curatives promote curing by catalytic action, others participate directly in the reaction of the epoxy resin and are incorporated into the thermoset polymeric network formed by condensation, chain-extension and/or crosslinking of the resin. It is particularly desirable to employ at least one curative which is a nitrogen-containing compound. Such curatives (along with other curatives useful for hardening epoxy resins) are described in the chapter in the Encyclopedia of Polymer and Engineering referenced hereinabove. Latent curatives (i.e., curatives that activate only heating to an elevated temperature) are preferred for use where the thermosettable composition is to be stored for an extended period of time at room temperature prior to use.

Suitable nitrogen-containing compounds useful as curatives include amino compounds, amine salts, and quaternary ammonium compounds. Particularly preferred types of nitrogen-containing compounds include amine-epoxy adducts, boron trihalide amine adducts, imidazoles, ureas, and guanidines (e.g., dicyandiamide). In one desirable embodiment of the invention, two or more different types of these nitrogen-containing compounds are used in combination.

Amine-epoxy adducts are well-known in the art and are described, for example, in U.S. Pat. Nos. 3,756,984; 4,066,625; 4,268,656; 4,360,649; 4,542,202; 4,546,155; 5,134,239; 5,407,978; 5,543,486; 5,548,058; 5,430,112; 5,464,910; 5,439,977; 5,717,011; 5,733,954; 5,789,498; 5,798,399 and 5,801,218, each of which is incorporated herein by reference in its entirety. Such amine-epoxy adducts are the products of the reaction between one or more amine compounds and one or more epoxy compounds. Carboxylic acid anhydrides, carboxylic acids, phenolic novolac resins, water, metal salts and the like may also be utilized as additional reactants in the preparation of the amine-epoxy adduct or to further modify the adduct once the amine and epoxy have been reacted. Preferably, the adduct is a solid which is insoluble in the epoxy resin component of the present invention at room temperature, but which becomes soluble and functions as an accelerator to increase the cure rate upon heating. While any type of amine could be used (with heterocyclic amines and/or amines containing at least one secondary nitrogen atom being preferred), imidazole compounds are particularly preferred. Illustrative imidazoles include 2-methyl imidazole, 2,4-dimethyl imidazole, 2-ethyl-4-methyl imidazole, 2-phenyl imidazole and the like. Other suitable amines include, but are not limited to, poperazines, piperidines, pyrazoles, purines, and triazoles. Any kind of epoxy compound can be employed as the other starting material for the adduct, including monofunctional, bifunctional, and polyfunctional epoxy compounds such as those described previously with regard to the epoxy resin component. Suitable amine-epoxy adducts are available from commercial sources such as Ajinomoto, Inc., Shell, Pacific Anchor Chemical Company, and the Asahi Chemical Industry Company Limited, The products sold by Ajinomoto under the trademarks AJICURE PN-40 and AJICURE PN-23 are especially preferred for use in the present invention.

Dicyandiamide (sold commercially by Air Products under the trademark DICY) is also a particularly preferred curative, although other guanidine compounds may also be utilized. The curative system may also comprise one or more ureas, either alone or in combination with other types of curatives (especially guanidines such as dicyandiamide). Suitable ureas include alkyl and aryl substituted ureas. Many such ureas are available commercially, for example, N,N′-dimethyl urea, which is sold under the trademark AMICURE UR by Air Products.

Suitable boron trihalide adducts include boron trichloride adducts of amines such as monoethanolamine, diethylamine, dioctylmethylamine, triethylamine, pyridine, benzylamine, benzyldimethyl amine, and the like. Boron trichloride amine adduct curatives are available commercially from companies such as Ciba Specialty Chemicals and CVC Specialty Chemicals, Inc.

The curative system (i.e., the specific curatives and the amounts of such curatives) should, in one desirable embodiment, be selected such that it does not catalyze curing of the thermosettable composition to any significant extent under typical storage conditions over an extended period of time.

Selection of the blowing agent or blowing agents to be used in the present invention is not believed to be particularly critical, although chemical blowing agents and/or encapsulated physical blowing agents rather than non-encapsulated physical blowing agents are preferred if a storage-stable, ready-to-use one-part composition is desired. Any of the chemical blowing agents known in the art may be employed, with azodicarbonamide (also sometimes referred to as 1,1′-azobisformamide, AZDC or ADC) and sulfonyl hydrazides providing particularly good performance. In one embodiment of the invention, azodicarbonamide is utilized as the predominate or, more preferably, sole blowing agent; mixtures with sulfonylhydrazides may be desirable for certain purposes, however. Azodicarbonamide is available from a number of commercial sources; for example, it is sold under the trademark UNICELL by Dong Jin Chemical of South Korea and under the CELOGEN trademark by Uniroyal Chemical. “Activated” or “modified” forms of azodicarbonamide may be used to advantage. Suitable sulfonylhydrazide blowing agents include, but are not limited to, p,p′-oxybis (benzenesulfonylhydrazide) (sold by Uniroyal Chemical under the trademark CELOGEN TSH) and the like. The particle size of the blowing agent may be adjusted so as to provide the desired foaming characteristics in the cured foam. Smaller particle sizes, for example, tend to provide foams having more uniform cell structure.

Expandable thermoplastic resin microspheres (which can comprise, for example, volatile physical blowing agents such as hydrocarbons or halocarbons encapsulated in thermoplastic shells) may also be employed to render the thermosettable composition foamable. Particularly preferred expandable microspheres are available from the Casco Products unit of Akzo Nobel AB under the trademark EXPANCEL.

In some formulations, it may be desirable to also use a blowing agent activator or accelerator so as to lower the temperature at which release of gas from the blowing agent takes place. Suitable blowing agent activators include, but are not limited to, ureas (such as the surface-coated, oil-treated urea sold by Uniroyal Chemicals under the trademark BIK-OT), polyols, organic acids, amines, and lead, zinc, tin, calcium and cadmium oxides and salts (including carboxylic acid salts). Typically, from about 0.01% to about 1% blowing agent activator based on the weight of the thermosettable composition is employed, although the optimum amount will of course vary depending upon the activator/accelerator selected, the amount of blowing agent, cure temperature and other variables.

It will be especially desirable to include one or more glass fillers in the thermosettable composition, as such fillers impart useful characteristics to the resulting foam. For example, hollow glass microspheres may be added to reduce the density of the foam while maintaining good strength and stiffness. Commercially available hollow glass microspheres (sometimes also referred to as glass microballoons or microbubbles) include the materials sold by Minnesota Mining & Manufacturing under the trademark SCOTCHLITE, with suitable grades including those available under the designations B38, C15, K20 and VS 5500. The glass microspheres preferably have diameters in the range of from about 5 to 200 micrometers (preferably, no greater than 70 micrometers). The crush strength of the hollow glass microspheres may be selected in accordance with the desired characteristics of the cured thermoset or composite containing such thermoset. Glass fiber is another preferred type of glass filler, since it helps increase the strength and stiffness of the thermoset. The glass fiber may be chopped, milled or in other suitable physical form.

Other types of fillers may also optionally be present in the thermosettable composition. Any of the conventional organic or inorganic fillers known in the thermosettable resin art may be used including, for example, silica (including fumed or pyrogenic silica, which may also function as a thixotropic or rheological control agent), calcium carbonate (including coated and/or precipitated calcium carbonate, which may also act as a thixotropic or rheological control agent, especially when it is in the form of fine particles), fibers other than glass fibers (e.g., wollastonite fibers, carbon fibers, ceramic fibers, aramid fibers), calcium oxide, wollastonite, alumina, clays, sand, metals (e.g., aluminum powder), microspheres and macrospheres comprised of materials other than glass such as ceramics, thermoplastic resins, thermoset resins, and carbon (all of which may be solid or hollow, expanded or expandable) and the like.

Other optional components include diluents (reactive or non-reactive) such as glycidyl ethers, glycidyl esters, acrylics, solvents and plasticizers, toughening or flexibilizing agents (e.g., aliphatic diepoxides, polyaminoamides, liquid polysulfide polymers), wetting agents/adhesion promoters, colorants) e.g., dyes and pigments such as carbon black), stabilizers (e.g., antioxidants, UV stabilizers), thermoplastic resins and the like.

It is particularly advantageous to include or more rubbers in the thermosettable composition, as such additives will toughen the thermoset and reduce the tendency of the thermoset to crack under stress. As used herein, the term “rubbers” includes both rubbers and elastomers. Suitable rubbers include thermoplastic as well as thermosettable (reactive) rubbers. Illustrative types of rubber include styrene-butadiene rubbers (SBR), nitrile-butadiene rubbers, butyl rubbers, polyisoprene, natural rubber, polybutadiene, chlorobutyl rubbers (neoprene), isobutylene polymers, alpha-olefin elastomers, ethylene-propylene elastomers, chlorosulfonated polyethylenes, ethylene-propylene-diene (EPDM) rubbers, ethylene-vinyl acetate rubbers, halogenated rubbers, hydrogenated natural rubbers, and the like. Thermoplastic block copolymers are one particularly preferred class of rubbers for use in the present invention. Such materials contain one or more base segments (“A”) covalently bonded to one or more soft or elastomeric segments (“B”). The A segments may be polystyrene, poly (alpha-methylstyrene), polyethylene, polyurethane, polysulfone, polyester, polycarbonate or the like. The B segments may be polybutadiene, polyisoprene, poly (ethylene-cobutylene), polydimethylsiloxane, polyether, or the like. The block copolymers may have a linear, branched, radial or star structure and may, for example, correspond to the general structure A-B-A, (A-B)ₙ, and so forth. SIS, SEBS and SBS block copolymers are examples of specific types of such materials. Liquid rubbers such as butadiene-acrylonitrile copolymers, which may be functionalized with carboxy groups, epoxy groups, amine groups, or other groups capable of reacting with other components of the thermosettable composition, may also be employed.

The thermosettable compositions of the present invention may be utilized in any end-use application where a foamed adhesive, sealant or coating is required. However, the thermosettable compositions are especially useful in the production of automobiles and other vehicles to maintain or increase the strength of structural members such as rockers, pillars, radiator support beams, doors, reinforcing beams and the like. The use of structural reinforcement foams in such applications is described, for example, in U.S. Pat. Nos. 4,901,500; 4,908,930; 4,751,249; 4,978,562; 4,995,545; 5,124,186; 5,575,526; 5,755,486; 4,923,902; 4,922,596; 4,861,097; 4,732,806; 4,695,343; 4,610,836; 6,068,424; 6,058,673; 6,003,274; 5,992,923; 5,888,600; 6,092,864; 6,079,180 and 5,884,960 (each of which is incorporated herein by reference in its entirety).

To improve the corrosion resistance of a composite comprised of a metal substrate and the foam, the thermosettable composition may additionally include one or more coupling agents and/or metal-modified inorganic oxides. Suitable coupling agents include silanes and organometallates such as organic titanates and zirconates. Organic titanates and zirconates are well known in the art and are described, for example, in U.S. Pat. No. 6,103,784, which is incorporated herein by reference in its entirety. Suitable metal-modified inorganic oxides include alkaline earth metal-modified silicates, for example, calcium ion exchanged amorphous silica gels such as the SHIELDEX products available from the Grace Davison division of W. R. Grace.

The relative amounts of the above-described components may, in particular embodiments of the invention, correspond to the following ranges:

| | | More |
|---|---|---|
| | Preferred (wt %) | Preferred (wt %) |
| Epoxy Resin (s)* | 30-90 | 40-70 |
| Blowing Agent (s) | 0.1-15 | 0.5-8 |
| Isocyanate Resin (s) | 0.1-20 | 0.5-5 |
| Epoxy Curative (s) | 0.1-20 | 1-10 |
| Rubber (s) | 0-25 | 1-10 |
| Adhesion Promoter (s) | 0-5 | 0.01-1 |
| Urethane Catalyst (s) | 0-2 | 0.01-0.5 |
| Blowing Agent Accelerator (s) | 0-2 | 0.01-1 |
| Hollow Glass Microspheres | 0-50 | 10-40 |
| Filler(s)** | 0-30 | 1-20 |
| Thixotropic Agent (s) | 0-10 | 0.1-5 |

*includes the amount of epoxy resin adducted with the isocyanate as well as the amount of non-adducted (non-reacted) epoxy resin
**other than hollow glass microspheres and thixotropic agents

In a preferred embodiment of the invention, the thermosettable composition is prepared in a stepwise manner. In a first step, the liquid and/or semi-solid epoxy resin is combined with the other desired components of the thermosettable composition other than the isocyanate resin (e.g., blowing agents, fillers, hollow glass microspheres, thixotropic agents, rubbers, epoxy curatives, urethane catalysts). Mixing of the epoxy resin and the other components is performed under conditions effective to achieve a uniform consistency. The resulting uniform mixture is thereafter combined with one or more isocyanate resins under conditions effective to accomplish the desired degree of reaction between the epoxy resin and the isocyanate resin, thereby forming the adduct in situ. Conditions which would initiate curing and/or foaming of the mixture are avoided, however.

The preferred finished expandable thermosettable compositions of the present invention are relatively rigid, low in surface tack, and are capable of being formed or molded into a desired shape and maintaining said desired shape over an extended period of time when stored at ambient temperatures and not subjected to any deforming forces other than the force of gravity. The expandable thermosettable composition may be shaped by extrusion, pressing, molding or other such means into shapes such as blocks, sheets, flat ribbons, cylinders, beads, rings, pellets, and the like. In some cases, the composition may be more easily worked by heating the composition to a temperature in excess of ambient temperature but less than the temperature at which curing and/or foaming begin to occur at a significant rate.

For example, the composition may be conformed to follow the contours of an irregular surface or to fit within a cavity of a certain size and configuration. The composition may be fastened, either adhesively or by mechanical means, to the surface of a carrier (which may be comprised of metal, heat-resistant plastic, or the like) to form a preform part useful as an insert for reinforcing a hollow member of an assembly such as a motor vehicle. Alternatively, the composition may be used directly (without a carrier). Once positioned in the location where structural reinforcement is needed, the composition can be cured and expanded by heating. The temperature required for curing and foaming will vary, of course, depending upon the particular components of the composition (especially the epoxy curative(s) and blowing agent(s) utilized). In one desirable embodiment of the invention, however, the composition is heated at a temperature of at least about 250° F. (about 120° C.) or, more preferably, at least about 300° F. (about 150° C.). Generally speaking, the composition will be formulated such that expansion and curing are substantially completed within a time of from about 5 minutes to about 1 hour.

### EXAMPLE

This example demonstrates the preparation of an expandable thermosettable composition in accordance with the invention.

The following components were charged to a double planetary mixer:

| | |
|---|---|
| 530.2 g | PEP 6134 high viscosity semi-solid DGEPA epoxy |
| | resin (supplied by Peninsula Polymers, Inc., |
| | Overland Park, Kansas; EEW = 240) |
| 47.5 g | NIPOL 112 liquid nitrile rubber (supplied by Zeon |
| | Chemicals L. P., Louisville, Kentucky) |
| 0.4 g | Z6020 silane adhesion promoter (supplied by Dow |
| | Corning Corporation, Midland, Michigan) |
| 18.1 g | NYAD G wollastonite (supplied by Nyco Minerals |
| | Inc.) |
| 14.5 g | UNICELL D azodicarbonanide blowing agent |
| | (supplied by Dong Jim Chemical Co., South |
| | Korea) |

After mixing for 10 minutes, 234 g SCOTCHLITE V55500 hollow glass microspheres (supplied by Minnesota Mining and Manufacturing) were added. After mixing for an additional 10 minutes, the following further components were added:

| | |
|---|---|
| 2 g | K-KAT 348 bismuth carboxylate urethane catalyst |
| | (supplied by King Industries) |
| 10 g | AJICURE PN-40 epoxy curative (supplied by |
| | Ajinomoto Chemicals) |
| 55 g | ULTRAFLEX calcium carbonate (supplied by |
| | Pfizer) |
| 22.5 g | CAB-O-SIL TS-720 fumed silica (supplied by |
| | Cabot Corporation) |
| 2.5 g | BIK-OT urea blowing agent activator (supplied by |
| | Uniroyal Chemicals) |
| 40.7 g | AMICUR CG-200 dicyandiamide epoxy curative |
| | (supplied by Air Products) |

After mixing for an additional 10 minutes, 37.1 g DESMODUR N-3300 isocyanate (HDI trimer having an NCO content of 21.8±0.3%; supplied by Bayer) were added. After mixing for an additional 10 minutes, a vacuum of 20 to 25 inches Hg was applied and mixing continued for an additional 10 minutes. The temperature during the entire aforedescribed mixing procedure was maintained in the range of from 43° C. (110° F.) to 66° C. (150° F.).

The product thereby obtained was hard and leathery at ambient temperatures with significantly lower tack than an analogous composition in which the isocyanate resin component was omitted. The lap shear pull for a 4 mm×25 mm×25 mm cured joint on cold rolled steel (0.060 inch substrate thickness) was 1617 Newtons.

Compressive modulus =1058 Mpa

Needle penetration (uncured; 50 g, 5 secs. at 25° C.)=1.1 mm

Free volumetric expansion (5 g, 30 min at 177° C.)=58%

The properties of an analogous (comparative) composition in which the isocyanate resin component was omitted were as follows:

Lap shear=1643 N

Compressive modulus=999 Mpa

Needle penetration=4.7 mm

Free volumetric expansion=45%

The needle penetration value was much higher for the comparative composition, confirming that it would be less dimensionally stable than the expandable thermosettable composition prepared in accordance with the present invention.

What is claimed is:

1. An expandable thermosettable composition useful for producing a structural adhesive foam comprising:
(a) at least one adduct of at least one isocyanate resin and at least one liquid or semi-solid epoxy resin bearing at least one isocyanate-reactive functional group per molecule;
(b) one or more blowing agents; and
(c) one or more epoxy curatives.

2. The composition of claim 1 wherein the liquid or semi-solid epoxy resin is a glycidyl ether of a polyhydric phenol.

3. The composition of claim 2 wherein the polyhydric phenol is bisphenol A.

4. The composition of claim 1 wherein the liquid or semi-solid epoxy resin is a diglycidyl ether of bisphenol A having an epoxy equivalent weight of from about 180 to about 300.

5. The composition of claim 1 wherein at least one isocyanate resin is an aliphatic polyisocyanate.

6. The composition of claim 1 wherein at least one isocyanate resin has at least three isocyanate groups per molecule.

7. The composition of claim 1 wherein at least one isocyanate resin is a trimer of a diisocyanate.

8. The composition of claim 1 wherein at least one isocyanate resin is an HDI trimer.

9. The composition of claim 1 additionally comprising one or more urethane catalysts.

10. The composition of claim 1 additionally comprising one or more urethane catalysts selected from the group consisting of bismuth compounds, tin compounds, and combinations thereof.

11. The composition of claim 1 additionally comprising hollow glass microspheres.

12. The composition of claim 1 additionally comprising one or more rubbers.

13. The composition of claim 1 additionally comprising one or more adhesion promoters selected from the group consisting of silanes, titanates, zirconates, and mixtures thereof.

14. The composition of claim 1 wherein one or more of the epoxy curatives are selected from the group consisting of guanidines, amine epoxy adducts and mixtures thereof.

15. The composition of claim 1 additionally comprising one or more fillers.

16. The composition of claim 1 additionally comprising one or more fillers selected from the group consisting of calcium carbonate, wollastonite, glass fibers, polyaramid fibers and mixtures thereof.

17. The composition of claim 1 additionally comprising one or more thixotropic agents.

18. The composition of claim 1 additionally comprising one or more thixotropic agents selected from the group consisting of fumed silica, calcium carbonate and mixtures thereof.

19. The composition of claim 1 wherein one or more of the blowing agents is selected from the group consisting of azo compounds, sulphonylhydrazides, expandable thermoplastic shells having one or more volatile compounds contained therein, and mixtures thereof.

20. The composition of claim 1 additionally comprising one or more blowing agent accelerators.

21. An expandable thermosettable composition useful for producing a structural adhesive foam comprising:
(a) at least one adduct of at least one isocyanate resin having at least two isocyanate groups per molecule and at least one liquid or semi-solid epoxy resin bearing at least one hydroxyl group per molecule, wherein said at least one liquid or semi-solid epoxy resin is a glycidyl ether of bisphenol A;
(b) one or more blowing agents;
(c) one or more epoxy curatives; and
(d) one or more additional components selected from the group consisting of:
(i) urethane catalysts;
(ii) hollow glass microspheres;
(iii) rubbers;
(iv) adhesion promoters;
(v) fillers;
(vi) thixotropic agents; and
(vii) epoxy resins other than said at least one liquid or semi-solid epoxy resin adducted with said isocyanate resin.

22. The expandable thermosettable composition of claim 21, wherein said expandable thermosettable composition is prepared using 30 to 90 wt % of epoxy resin, 0.1 to 15 wt % of said blowing agent, 0.1 to 20 wt % of said at least one isocyanate resin, and 0.1 to 20 wt % of said epoxy curatives.

23. The expandable thermosettable composition of claim 21 wherein the said at least one liquid or semi-solid epoxy resin is a diglycidyl ether of bisphenol A having an epoxy equivalent weight of from about 180 to about 300.

24. The expandable thermosettable composition of claim 21 wherein at least one isocyanate resin is an aliphatic polyisocyanate.

25. The expandable thermosettable composition of claim 21 wherein at least one isocyanate resin has at least three isocyanate groups per molecule.

26. The expandable thermosettable composition of claim 21 wherein at least one isocyanate resin is a trimer of a diisocyanate.

27. The expandable thermosettable composition of claim 21 wherein at least one isocyanate resin is an HDI trimer.

28. An expandable thermosettable composition useful for producing a structural adhesive foam comprising:
(a) 40 to 70 wt % of one or more epoxy resins;
(b) 0.5 to 8 wt % of one or more blowing agents;
(c) 0.5 to 5 wt % of one or more isocyanate resins;
(d) 1 to 10 wt % of one or more epoxy curatives;
(e) 1 to 10 wt % of one or more rubbers;
(f) 0.01 to 1 wt % of one or more adhesion promoters;
(g) 0.01 to 0.5 wt % of one or more urethane catalysts;
(h) 0.01 to 1 wt % of one or more blowing agent accelerators;
(i) 10 to 40 wt % of hollow glass microspheres;
(j) 1 to 20 wt % of one of more fillers; and
(k) 0.1 to 5 wt % of one or more thixotropic agents;
wherein at least a portion of the epoxy resins are liquid or semi-solid epoxy resins having at least one isocyanate-reactive functional group per molecule which have been reacted with at least a portion of the isocyanate resins to form an adduct.

29. A method of filling and reinforcing a hollow member of an assembly comprising the steps of:
(a) placing a portion of the thermosettable expandable composition of claim 1 within said hollow member; and
(b) heating said portion of said thermosettable expandable composition for a time and at a temperature effective to expand and cure said thermosettable expandable composition.

30. The method of claim 29 wherein said portion is fastened to a carrier.

31. A method of making an expandable thermosettable composition useful for producing a structural adhesive foam, said method comprising:
(a) combining at least one liquid or semi-solid epoxy resin bearing at least one isocyanate-reactive functional group, one or more blowing agents, and one or more epoxy curatives to form a uniform mixture; and
(b) reacting at least a portion of the liquid or semi-solid epoxy resin in said mixture with at least one isocyanate resin to form an adduct.
